(19) United States
(12) Patent Application Publication
(10) Pub. No.: US 2026/0017241 A1
(43) Pub. Date: Jan. 15, 2026

(54) MACHINE LEARNING BASED REDUCTION OF PROVISIONED DATA

(71) Applicant: SAP SE, Walldorf (DE)

(72) Inventors: Wulf Kruempelmann, Altlussheim (DE); Susanne Schott, Walldorf (DE); Fabian Klumpp, Frankenthal (DE)

(21) Appl. No.: 18/771,161

(22) Filed: Jul. 12, 2024

(51) Int. Cl. G06F 16/21; G06N 3/0475; G06N 3/084

(52) U.S. Cl. CPC G06F 16/217; G06N 3/0475; G06N 3/084

(57) ABSTRACT

A machine learning model is trained to predict which subset of programs and tables should be used for provisioning a new database instance. In an example, the training includes receiving organization categorization data for a plurality of entities, collecting usage statistics for the plurality of entities, providing the organization categorization data as inputs to the machine learning model, and providing the usage statistics as desired outputs to the machine learning model during training to generate a trained version of the machine learning model. Later, a first set of organization categorization data of a first entity are provided as inputs to the trained version of the machine learning model which determines a first subset of programs and tables which are predicted to be required by the first entity. Then, a first database instance is provisioned with the first subset of programs and tables to be deployed for the first entity.

### TECHNICAL FIELD

The present disclosure generally relates to machine learning techniques for reducing provisioned data in an enterprise resource planning system.

### BACKGROUND

An application can be hosted by a cloud platform such that the application can be remotely accessible to multiple tenants, for example, over the Internet. For example, the application can be available as a cloud-based service including, for example, a software as a service (SaaS) and/or the like. Many organizations rely on such cloud-based enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. An ERP system includes software and technical configuration data for all business processes. The provisioning of an ERP system generates a huge database load with a size that can be several hundred GigaBytes (GBs).

### SUMMARY

In some implementations, a machine learning model is trained to predict which subset of programs and tables should be used for provisioning a new database instance. In an example, the training includes receiving a plurality of sets of organization categorization data for a plurality of entities, collecting usage statistics for the plurality of entities, where the usage statistics indicate which programs and tables are utilized by each entity of the plurality of entities, providing the plurality of sets of organization categorization data as inputs to the machine learning model, and providing the usage statistics as desired outputs to the machine learning model during training to generate a trained version of the machine learning model. Later, a first set of organization categorization data of a first entity are provided as inputs to the trained version of the machine learning model. Next, the trained version of the machine learning model determines a first subset of programs and tables which are predicted to be required by the first entity. Then, a first database instance is provisioned with the first subset of programs and tables to be deployed for the first entity.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a logical block diagram of an enterprise resource planning (ERP) system, in accordance with some example implementations of the current subject matter;

FIG. 3 illustrates a block diagram of a deployment engine, in accordance with some example implementations of the current subject matter;

FIG. 4 illustrates a block diagram of a deployment engine, in accordance with some example implementations of the current subject matter;

FIG. 5 illustrates an example of a process for deploying a subset of tables and functions to a customer's database, in accordance with some example implementations of the current subject matter;

FIG. 6 illustrates an example of a process for persisting predicted data in a customer-specific database load, in accordance with some example implementations of the current subject matter;

FIG. 7 illustrates an example of a process for determining how to provision a database instance in an ERP system, in accordance with some example implementations of the current subject matter;

FIG. 8A depicts an example of a system, in accordance with some example implementations of the current subject matter; and

FIG. 8B depicts another example of a system, in accordance with some example implementations of the current subject matter.

### DETAILED DESCRIPTION

The provisioning of an enterprise resource planning (ERP) system generates a huge database load with a size of several 100 GigaBytes. The ERP system includes software and technical configuration data for all business processes. Most users of such systems require only selected processes and therefore a subset of data. As the data is highly integrated, there is no classical way to select the required functions and data for the customer processes.

Since ERP system are used by large numbers of customers, there are good statistics for used processes available. During implementation, the customer selects the required business processes and develops the corresponding business solution. As derived from the statistical data the mostly used configuration data is transported into the productive system of the customer. During the usage of the system, the ERP vendor tracks the usage of vendor owned data, like programs, tables and table content and stores this information in a database. Additionally, the vendor knows the selected processes as well as the industry information of the customer.

In some embodiments, anonymized customer data may be provided as an input to a machine learning (ML) instance. The anonymized customer data includes data such as the customer's industry (e.g., car builder), subset of industry (e.g., part provider for electronics for cars), size of the company (e.g., 10,000 employees), employee structure, country (e.g., United States), manufacturing method, number of plants, country of plants, and so on. The anonymized customer data may also be linked to the selected processes and the used tables. The ML instance determines correlations between the customer entities. For new customers, the vendor enters the customers organizational data. The ML returns the required tables and functions. Only these required tables and functions are deployed to the customer database and can reduce the initial size of the database by a large percentage (e.g., 75%).

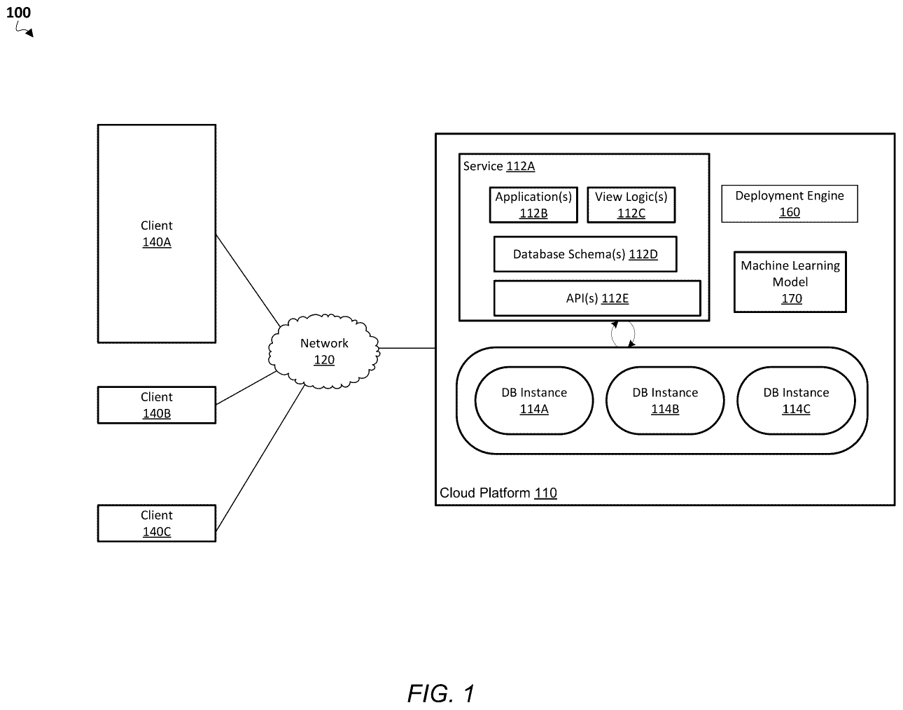

FIG. 1 depicts a diagram illustrating an example of a system 100 consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

Deployment engine 160 may manage the deployment of database instances 114A-C. In an example, deployment engine 160 utilizes machine learning model 170 to determine which of the customers tables and functions to deploy to a database instance 114A-C based on the customers organizational data. Machine learning model 170 is representative of any of various types of machine learning models. For example, machine learning model 170 may be a neural network, recurrent neural network, convolutional neural network, generative model, generative neural network, generative adversarial network, generative pre-trained transformer, diffusion model, etc. Other types of machine learning models are possible and are contemplated.

Machine learning model 170 may be trained with anonymized customer data and customer usage statistics. When a new customer is being provisioned, deployment engine 160 may provide the new customer's organizational data as an input to a trained version of machine learning model 170. In response, the trained version of machine learning model 170 may provide an output identifying the required tables and functions for the new customer. Deployment engine 160 may then generate a new database instance 114A-C for the new customer with only these required tables and functions, helping to reduce the initial size of the database instance 114A-C. It is noted that although some of the examples refer to a deployment engine 160, aspects of the deployment engine may be deployed in one or more of the database instances 114A-C, the service 112A, the view logic 112C, the application 112B, and/or at other components of the cloud platform 110.

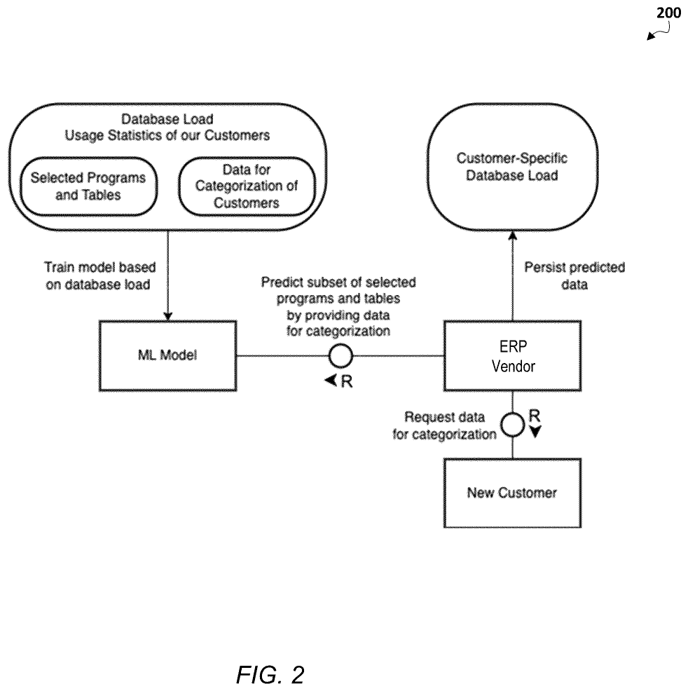

Turning now to FIG. 2, a logical block diagram of an enterprise resource planning (ERP) system 200 is shown, in accordance with one or more embodiments of the current subject matter. In an example, an ERP vendor may have a large number of customers, and the ERP vendor may collect statistics for the processes used by their customers. During deployment, a given customer selects the required business processes and develops the corresponding business solution. As derived from the statistical data, the mostly used configuration data is transported into the productive system of the customer. During the usage of the system, the ERP vendor tracks the usage of vendor owned data, like programs, tables and table content and stores this information in a database. The ERP vendor also knows and stores the selected processes as well as industry information of the customer.

A machine learning (ML) instance is provided with anonymized customer data, like industry (e.g., car builder), subset of industry (e.g., part provider for electronics for cars), size of the company (e.g., 100 employees), employee structure, country (e.g., United States), manufacturing method, number of plants, country of plants together with the selected processes and the used tables. The ML instance is queried for correlations between the customer entities. For new customers, the vendor enters the customers data and the selected processes. The ML returns the required tables and functions. Only these required tables and functions are deployed to the customer database and can reduce the initial size of the customer database by a significant percentage.

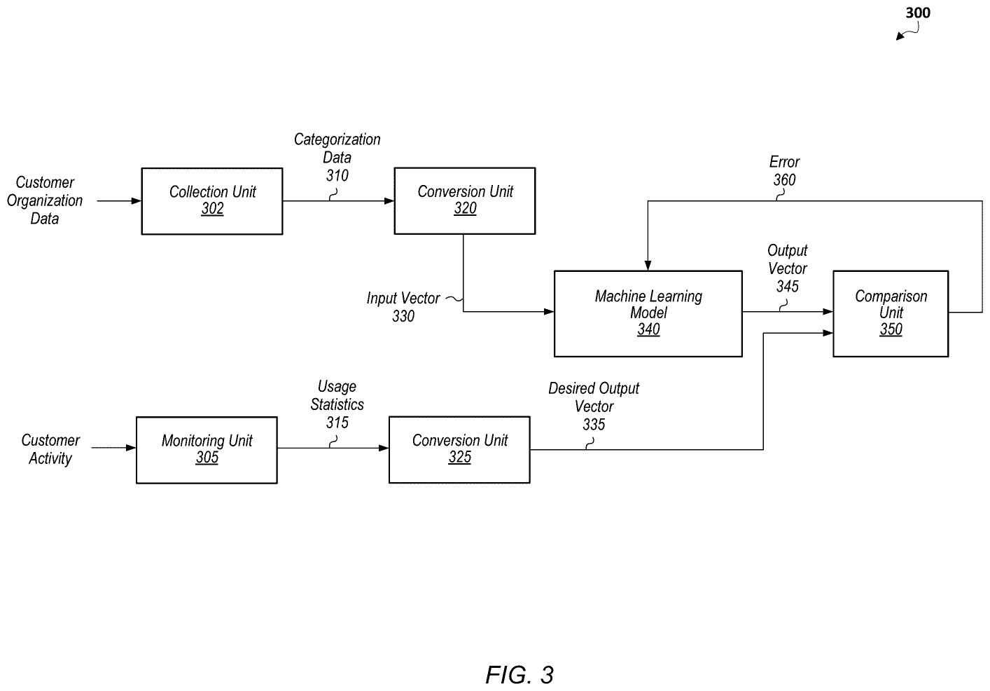

Referring now to FIG. 3, a block diagram of a deployment engine 300 is depicted, in accordance with one or more embodiments of the current subject matter. In an example, deployment engine 300 includes a collection unit 302 for collecting categorization data 310 from a plurality of customers, organizations, entities, and the like. Categorization data 310 includes data for each customer such as the customer's industry, customer's size, and so on. In this example, deployment engine 300 also includes monitoring unit 305 for monitoring the activities of the various customers, organizations, and entities, their usage of databases, their application usage, and so on. Based on monitoring the customer activity, monitoring unit 305 generates usage statistics 315.

For each entity, conversion unit 320 may convert a corresponding set of categorization data 310 into input vector 330 which is provided as a training input when training machine learning model 340. For each entity, conversion unit 325 may convert usage statistics 315 into desired output vector 335. Desired output vector 335 corresponds to a subset of data that should be provisioned in a database instance for a given entity based on the entity's set of usage statistics 315. During training, the output generated by machine learning model 340 is output vector 345. Output vector 345 is compared, by comparison unit 350, to desired output vector 335 to generate error 360. Error 360 is used to adjust the various neurons of the layers of machine learning model 340 before the next training run is performed. When error 360 falls below a threshold, the training of machine learning model 340 may terminate.

It is noted that each of the components of deployment engine 300 may be implemented using any suitable combination of hardware (e.g., circuitry, one or more processing units) and/or software (e.g., program instructions). Additionally, it should be understood that the structure and arrangement of components shown in FIG. 3 for deployment engine 300 is merely indicative of one particular embodiment. In other embodiments, other suitable structures and arrangements of components, may be employed. For example, in another embodiment, the functionality of some components may be combined together into a single component. In a further embodiment, the functionality of a single component may be partitioned into two or more components. Other alternatives are possible and are contemplated.

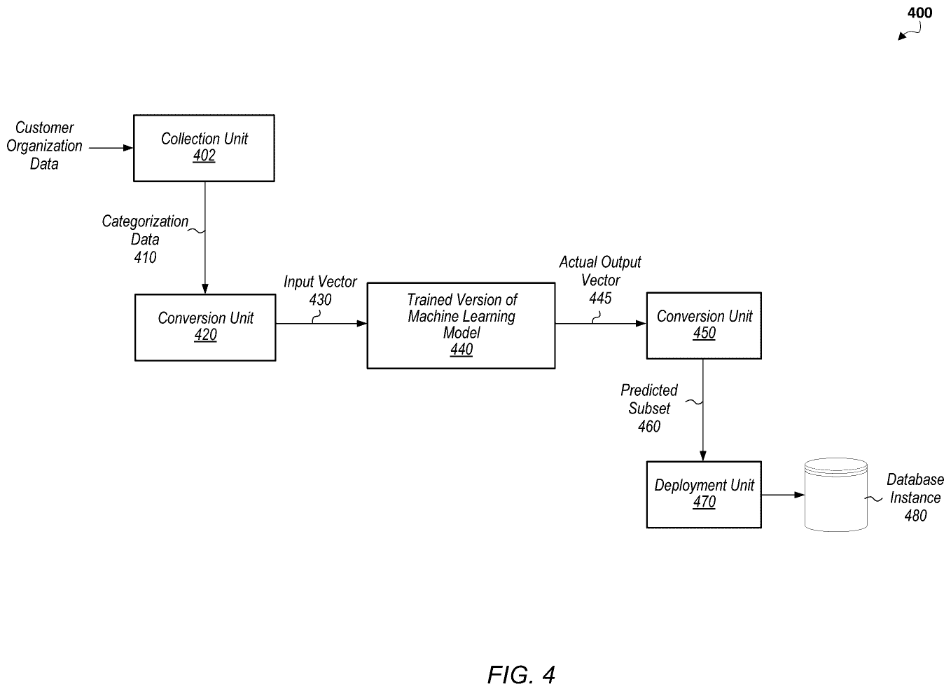

Turning now to FIG. 4, a block diagram of a deployment engine 400 is shown, in accordance with one or more embodiments of the current subject matter. In an example, deployment engine 400 includes a collection unit 402 for collecting categorization data 410 from a new customer. In this example, conversion unit 420 may convert the set of categorization data 410 into input vector 430 which is provided as an input to a trained version of machine learning model 440. It is assumed for the purposes of this discussion that machine learning model 440 has already been trained. Accordingly, in response to receiving input vector 440, machine learning model generates actual output vector 445 which is converted by conversion unit 450 into predicted subset 460. In an example, predicted subset 460 provides identifications of the subset of tables and functions that are predicted to be required by the new customer. Deployment unit 470 utilizes predicted subset 460 to provision database instance 480 for the new customer, with database instance 480 including only those tables and functions that are predicted to be needed by the new customer. This helps to reduce the time needed for provisioning database instance 480 as well as reducing the size of database instance 480. As used herein, the term “provisioning” may be defined as the process of installing and configuring a software resource and enabling use of the software resource by one or more users. “Provisioning” database instance 480 includes the deployment and configuration of a number of software components and database components to meet the needs of the intended users.

It is noted that each of the components of deployment engine 400 may be implemented using any suitable combination of hardware (e.g., circuitry, one or more processing units) and/or software (e.g., program instructions). Additionally, it should be understood that the structure and arrangement of components shown in FIG. 4 for deployment engine 400 is merely indicative of one particular embodiment. In other embodiments, other suitable structures and arrangements of components, may be employed. For example, in another embodiment, the functionality of some components may be combined together into a single component. In a further embodiment, the functionality of a single component may be partitioned into two or more components. Other alternatives are possible and are contemplated.

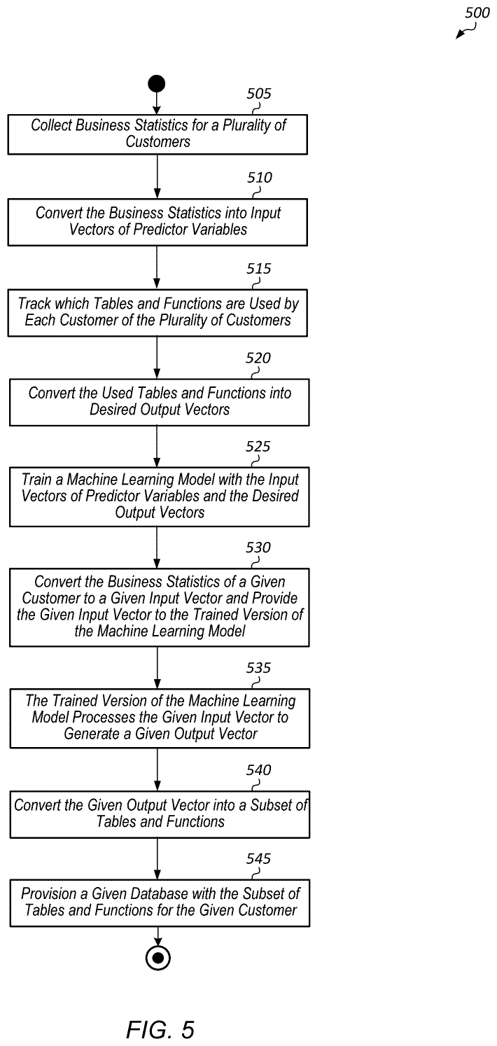

Referring now to FIG. 5, a process for deploying a subset of tables and functions to a customer's database is depicted, in accordance with one or more embodiments of the current subject matter. An ERP vendor collects business statistics for a plurality of customers (block 505). The ERP vendor converts the business statistics into input vectors of predictor variables (block 510). Also, the ERP vendor tracks which tables and functions are used by each customer of the plurality of customers (block 515). The ERP vendor converts the used tables and functions into desired output vectors (block 520).

Next, the ERP vendor trains a machine learning model with the input vectors of predictor variables (generated based on the business statistics) and the desired output vectors (generated based on the tables and functions used by each customer) (block 525). The result of the training is a trained version of the machine learning model. Then, the ERP vendor converts the business statistics of a given customer (e.g., a new customer) to a given input vector and provides the given input vector to the trained version of the machine learning model (block 530). Next, the trained version of the machine learning model processes the given input vector to generate a given output vector (block 535). Then, the ERP vendor converts the given output vector into a subset of tables and functions (block 540). Next, the ERP provisions a given database with the subset of tables and functions for the given customer (block 545). By provisioning the given database with only the subset of tables and functions, the initial size of the given database may be reduced by a significant percentage. After block 545, method 500 ends.

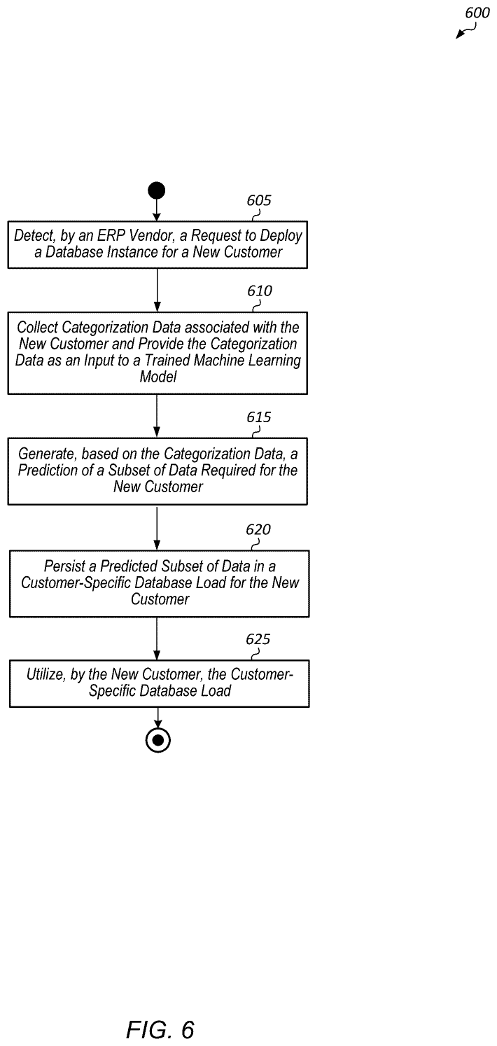

Turning now to FIG. 6, a process for persisting predicted data in a customer-specific database load is depicted, in accordance with one or more embodiments of the current subject matter. An ERP vendor detects a request to deploy a database instance for a new customer (block 605). Next, the ERP vendor collects categorization data associated with the new customer and provides the categorization data as an input to a trained machine learning model (block 610). The categorization data may include the industry of the new customer, subset of industry of the new customer, size of the new customer's company, employee structure, country (e.g., United States), manufacturing method, number of plants, country of plants, and so on. Then, the trained machine learning model generates, based on the categorization data, a prediction of a subset of data required for the new customer (block 615). The subset of data may refer to a subset of selected programs, tables, processes, tools, parameters, software functions, and so on that are predicted to be utilized by the new customer.

Next, the ERP vendor persists the predicted subset of data in a customer-specific database load for the new customer (block 620). This helps to reduce the database load as compared to the typical scenario where an ERP vendor loads all of the customer's ERP system data. Then, the new customer utilizes the customer-specific database load (block 625). After block 625, method 600 ends.

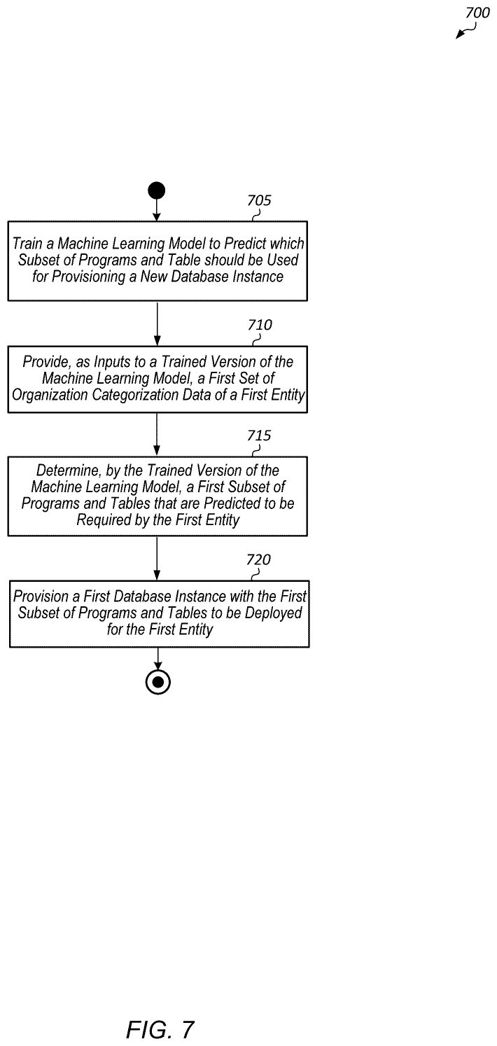

Referring now to FIG. 7, a process is depicted for determining how to provision a database instance in an ERP system, in accordance with one or more embodiments of the current subject matter. At the beginning of the process, a machine learning model is trained to predict which subset of programs and tables should be used for provisioning a new database instance (block 705). Next, a first set of organization categorization data of a first entity are provided as inputs to a trained version of the machine learning model (block 710). Then, the trained version of the machine learning model determines, based on receiving the first set of organization categorization data as inputs, a first subset of programs and tables that are predicted to be required by the first entity (block 715). Next, a deployment engine (e.g., deployment engine 160 of FIG. 1) provisions a first database instance with the first subset of programs and tables to be deployed for the first entity (block 720). After block 720, method 700 may end.

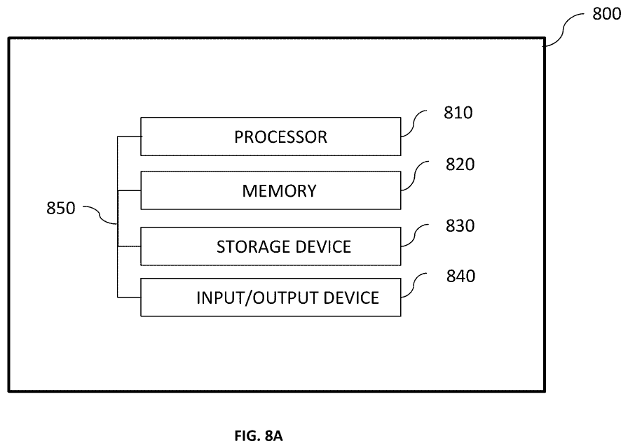

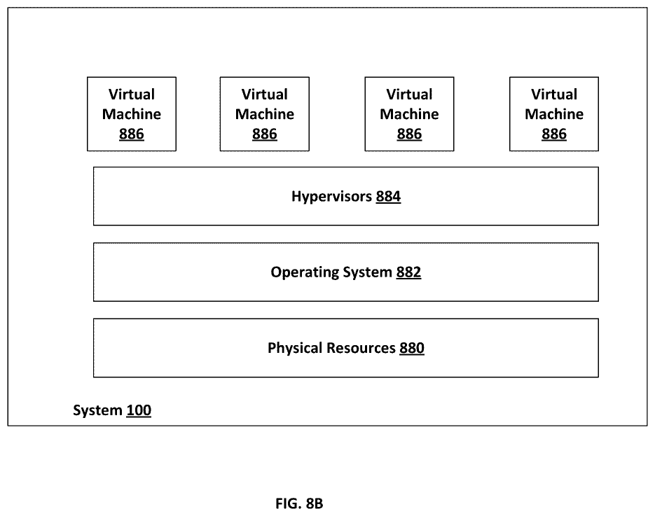

In some implementations, the current subject matter may be configured to be implemented in a system 800, as shown in FIG. 8A. The system 800 may include a processor 810, a memory 820, a storage device 830, and an input/output device 840. Each of the components 810, 820, 830 and 840 may be interconnected using a system bus 850. The processor 810 may be configured to process instructions for execution within the system 800. In some implementations, the processor 810 may be a single-threaded processor. In alternate implementations, the processor 810 may be a multi-threaded processor. The processor 810 may be further configured to process instructions stored in the memory 820 or on the storage device 830, including receiving or sending information through the input/output device 840. The memory 820 may store information within the system 800. In some implementations, the memory 820 may be a computer-readable medium. In alternate implementations, the memory 820 may be a volatile memory unit. In yet some implementations, the memory 820 may be a non-volatile memory unit. The storage device 830 may be capable of providing mass storage for the system 800. In some implementations, the storage device 830 may be a computer-readable medium. In alternate implementations, the storage device 830 may be a floppy disk device, a hard disk device, an optical disk device, a tape device, non-volatile solid state memory, or any other type of storage device. The input/output device 840 may be configured to provide input/output operations for the system 800. In some implementations, the input/output device 840 may include a keyboard and/or pointing device. In alternate implementations, the input/output device 840 may include a display unit for displaying graphical user interfaces.

FIG. 8B depicts an example implementation of the system 100 (of FIG. 1). The system 100 may be implemented using various physical resources 880, such as at least one or more hardware servers, at least one storage, at least one memory, at least one network interface, and the like. The system 100 may also be implemented using infrastructure, as noted above, which may include at least one operating system 882 for the physical resources 880 and at least one hypervisor 884 (which may create and run at least one virtual machine 886). For example, each multitenant application may be run on a corresponding virtual machine 886.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: training a machine learning model to predict which subset of programs and tables should be used for provisioning a new database instance, wherein the training comprises: receiving a plurality of sets of organization categorization data for a plurality of entities; collecting usage statistics for the plurality of entities, wherein the usage statistics indicate which programs and tables are utilized by each entity of the plurality of entities; and providing the plurality of sets of organization categorization data as inputs to the machine learning model and providing the usage statistics as desired outputs to the machine learning model during training to generate a trained version of the machine learning model; providing, as inputs to the trained version of the machine learning model, a first set of organization categorization data of a first entity; determining, by the trained version of the machine learning model, a first subset of programs and tables which are predicted to be required by the first entity; and provisioning a first database instance with the first subset of programs and tables to be deployed for the first entity.

Example 2: The computer-implemented method of Example 1, wherein identifications of the first subset of programs and tables are generated by the trained version of the machine learning model by processing the first set of organization categorization data of the first entity.

Example 3: The computer-implemented method of any of Examples 1, further comprising converting the plurality of sets of organization categorization data for the plurality of entities into a plurality of input vectors.

Example 4: The computer-implemented method of any of Examples 1-3, further comprising converting the usage statistics for the plurality of entities into a plurality of desired output vectors.

Example 5: The computer-implemented method of any of Examples 1-4, further comprising generating, by the machine learning model, an actual output vector for a second input vector for a second entity.

Example 6: The computer-implemented method of any of Examples 1-5, further comprising comparing the actual output vector to a second desired output vector corresponding to the second entity.

Example 7: The computer-implemented method of any of Examples 1-6, further comprising adjusting a plurality of neurons of a plurality of layers of the machine learning model based on a difference between the actual output vector and the second desired output vector.

Example 8: The computer-implemented method of any of Examples 1-7, further comprising utilizing, by the first entity, the first database instance as part of an enterprise resource planning system.

Example 9: A system comprising: at least one processor; and at least one memory storing instructions that, when executed by the at least one processor, cause operations comprising: training a machine learning model to predict which subset of programs and tables should be used for provisioning a new database instance, wherein the training comprises: receiving a plurality of sets of organization categorization data for a plurality of entities; collecting usage statistics for the plurality of entities, wherein the usage statistics indicate which programs and tables are utilized by each entity of the plurality of entities; and providing the plurality of sets of organization categorization data as inputs to the machine learning model and providing the usage statistics as desired outputs to the machine learning model during training to generate a trained version of the machine learning model; providing, as inputs to the trained version of the machine learning model, a first set of organization categorization data of a first entity; determining, by the trained version of the machine learning model, a first subset of programs and tables which are predicted to be required by the first entity; and provisioning a first database instance with the first subset of programs and tables to be deployed for the first entity.

Example 10: The system of Example 9, wherein identifications of the first subset of programs and tables are generated by the trained version of the machine learning model by processing the first set of organization categorization data of the first entity.

Example 11: The system of any of Examples 9-10, wherein the operations further comprise converting the plurality of sets of organization categorization data for the plurality of entities into a plurality of input vectors.

Example 12: The system of any of Examples 9-11, wherein the operations further comprise converting the usage statistics for the plurality of entities into a plurality of desired output vectors.

Example 13: The system of any of Examples 9-12, wherein the operations further comprise generating, by the machine learning model, an actual output vector for a second input vector for a second entity.

Example 14: The system of any of Examples 9-13, wherein the operations further comprise comparing the actual output vector to a second desired output vector corresponding to the second entity.

Example 15: The system of any of Examples 9-14, wherein the operations further comprise adjusting a plurality of neurons of a plurality of layers of the machine learning model based on a difference between the actual output vector and the second desired output vector.

Example 16: The system of any of Examples 9-15, wherein the operations further comprise utilizing, by the first entity, the first database instance as part of an enterprise resource planning system.

Example 17: A non-transitory computer readable medium storing instructions, which when executed by at least one data processor, result in operations comprising: training a machine learning model to predict which subset of programs and tables should be used for provisioning a new database instance, wherein the training comprises: receiving a plurality of sets of organization categorization data for a plurality of entities; collecting usage statistics for the plurality of entities, wherein the usage statistics indicate which programs and tables are utilized by each entity of the plurality of entities; and providing the plurality of sets of organization categorization data as inputs to the machine learning model and providing the usage statistics as desired outputs to the machine learning model during training to generate a trained version of the machine learning model; providing, as inputs to the trained version of the machine learning model, a first set of organization categorization data of a first entity; determining, by the trained version of the machine learning model, a first subset of programs and tables which are predicted to be required by the first entity; and provisioning a first database instance with the first subset of programs and tables to be deployed for the first entity.

Example 18: The non-transitory computer readable medium of Example 17, wherein identifications of the first subset of programs and tables are generated by the trained version of the machine learning model by processing the first set of organization categorization data of the first entity.

Example 19: The non-transitory computer readable medium of any of Examples 17-18, wherein the operations further comprise converting the plurality of sets of organization categorization data for the plurality of entities into a plurality of input vectors.

Example 20: The non-transitory computer readable medium of any of Examples 17-19, wherein the operations further comprise converting the usage statistics for the plurality of entities into a plurality of desired output vectors.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
training a machine learning model to predict which subset of programs and tables should be used for provisioning a new database instance, wherein the training comprises:
receiving a plurality of sets of organization categorization data for a plurality of entities;
collecting usage statistics for the plurality of entities, wherein the usage statistics indicate which programs and tables are utilized by each entity of the plurality of entities; and
providing the plurality of sets of organization categorization data as inputs to the machine learning model and providing the usage statistics as desired outputs to the machine learning model during training to generate a trained version of the machine learning model;
providing, as inputs to the trained version of the machine learning model, a first set of organization categorization data of a first entity;
determining, by the trained version of the machine learning model, a first subset of programs and tables which are predicted to be required by the first entity; and
provisioning a first database instance with the first subset of programs and tables to be deployed for the first entity.

2. The computer-implemented method of claim 1, wherein identifications of the first subset of programs and tables are generated by the trained version of the machine learning model by processing the first set of organization categorization data of the first entity.

3. The computer-implemented method of claim 1, further comprising converting the plurality of sets of organization categorization data for the plurality of entities into a plurality of input vectors.

4. The computer-implemented method of claim 3, further comprising converting the usage statistics for the plurality of entities into a plurality of desired output vectors.

5. The computer-implemented method of claim 4, further comprising generating, by the machine learning model, an actual output vector for a second input vector for a second entity.

6. The computer-implemented method of claim 5, further comprising comparing the actual output vector to a second desired output vector corresponding to the second entity.

7. The computer-implemented method of claim 6, further comprising adjusting a plurality of neurons of a plurality of layers of the machine learning model based on a difference between the actual output vector and the second desired output vector.

8. The computer-implemented method of claim 1, further comprising utilizing, by the first entity, the first database instance as part of an enterprise resource planning system.

9. A system comprising:
at least one processor; and
at least one memory storing instructions that, when executed by the at least one processor, cause operations comprising:
training a machine learning model to predict which subset of programs and tables should be used for provisioning a new database instance, wherein the training comprises:
receiving a plurality of sets of organization categorization data for a plurality of entities;
collecting usage statistics for the plurality of entities, wherein the usage statistics indicate which programs and tables are utilized by each entity of the plurality of entities; and
providing the plurality of sets of organization categorization data as inputs to the machine learning model and providing the usage statistics as desired outputs to the machine learning model during training to generate a trained version of the machine learning model;
providing, as inputs to the trained version of the machine learning model, a first set of organization categorization data of a first entity;
determining, by the trained version of the machine learning model, a first subset of programs and tables which are predicted to be required by the first entity; and
provisioning a first database instance with the first subset of programs and tables to be deployed for the first entity.

10. The system of claim 9, wherein identifications of the first subset of programs and tables are generated by the trained version of the machine learning model by processing the first set of organization categorization data of the first entity.

11. The system of claim 9, wherein the operations further comprise converting the plurality of sets of organization categorization data for the plurality of entities into a plurality of input vectors.

12. The system of claim 11, wherein the operations further comprise converting the usage statistics for the plurality of entities into a plurality of desired output vectors.

13. The system of claim 12, wherein the operations further comprise generating, by the machine learning model, an actual output vector for a second input vector for a second entity.

14. The system of claim 13, wherein the operations further comprise comparing the actual output vector to a second desired output vector corresponding to the second entity.

15. The system of claim 14, wherein the operations further comprise adjusting a plurality of neurons of a plurality of layers of the machine learning model based on a difference between the actual output vector and the second desired output vector.

16. The system of claim 9, wherein the operations further comprise utilizing, by the first entity, the first database instance as part of an enterprise resource planning system.

17. A non-transitory computer readable medium storing instructions, which when executed by at least one data processor, result in operations comprising:
training a machine learning model to predict which subset of programs and tables should be used for provisioning a new database instance, wherein the training comprises:
receiving a plurality of sets of organization categorization data for a plurality of entities;
collecting usage statistics for the plurality of entities, wherein the usage statistics indicate which programs and tables are utilized by each entity of the plurality of entities; and
providing the plurality of sets of organization categorization data as inputs to the machine learning model and providing the usage statistics as desired outputs to the machine learning model during training to generate a trained version of the machine learning model;
providing, as inputs to the trained version of the machine learning model, a first set of organization categorization data of a first entity;
determining, by the trained version of the machine learning model, a first subset of programs and tables which are predicted to be required by the first entity; and
provisioning a first database instance with the first subset of programs and tables to be deployed for the first entity.

18. The non-transitory computer readable medium of claim 17, wherein identifications of the first subset of programs and tables are generated by the trained version of the machine learning model by processing the first set of organization categorization data of the first entity.

19. The non-transitory computer readable medium of claim 17, wherein the operations further comprise converting the plurality of sets of organization categorization data for the plurality of entities into a plurality of input vectors.

20. The non-transitory computer readable medium of claim 19, wherein the operations further comprise converting the usage statistics for the plurality of entities into a plurality of desired output vectors.
